(19) United States
(12) Patent Application Publication
(10) Pub. No.: US 2004/0257320 A1
(43) Pub. Date: Dec. 23, 2004

(54) Computer device capable of displaying television programs without the need of executing an operating system

(76) Inventors: Ming-Chang Wang, Taoyuan City (TW); Chih Wen Liu, Taipei (TW); Wen Hsiung Chang, Yunlin Hsien (TW)

Correspondence Address: BIRCH STEWART KOLASCH & BIRCH, PO BOX 747, FALLS CHURCH, VA, 22040-0747, US

(21) Appl. No.: 10/600,355

(22) Filed: Jun. 23, 2003

(51) Int. Cl. G09G 3/36

(52) U.S. Cl. 345/87

(57) ABSTRACT

A computer device capable of displaying television programs without the need of running an operating system is disclosed. The computer device comprises a computer keyboard unit comprising a keyboard controller, a low-voltage differential signal (LVDS) transmitter. The LVDS transmitter has an output end connected to a LCD monitor. A television tuner module is installed in the computer keyboard unit and connected to the keyboard controller. The television tuner module has an output end connected to an audio amplifier having an output end connected to a speaker. A television control switch is installed on the computer keyboard unit and connected to a power switching module.

### BACKGROUND OF THE INVENTION

1. Field of the Invention

The present invention relates to a computer device capable of displaying television programs without the need of running an operating system in advance. More particularly, the present invention relates to a computer device that enables a user to watch cable television programs on a liquid crystal display (LCD) screen without the need of running Windows operating system.

2. Description of the Prior Art

It is often desirable that a computer user can use a desktop or laptop computer monitor to watch cable television programs. Conventionally, to watch cable television programs through a computer monitor, a user has to turn the monitor on (in a desktop computer case), boot his computer first and then wait for about 50 seconds to enter the Windows operating system. After that, he or she has to activate the application program of a television tuner module via the normal Windows interface. Only through the time-consuming process, the computer user can watch the television programs. The above-mentioned prior art process is not convenient to the computer users.

In light of foregoing, there is a strong need to provide an improved computer device such that one can watch cable television programs on the computer monitor without the need of entering Windows operating system.

### SUMMARY OF THE INVENTION

The main objective of the invention is to provide an improved computer device such that one can watch cable television programs on the computer LCD monitor without the need of entering Windows operating system, thereby creating the appendant value of the personal computers.

Another objective of the present invention is to provide a computer device, which is controlled by a remote control, such that one can watch cable television programs on the computer LCD monitor without the need of entering Windows operating system for convenience.

Still another objective of the present invention is to provide a computer device that enables a user to watch TV programs in an alternative manner.

According to the claimed invention, a computer device capable of displaying television programs without the need of running an operating system in advance is disclosed. The computer device comprises a computer keyboard unit comprising a keyboard controller, a low-voltage differential signal (LVDS) transmitter, wherein the LVDS transmitter has an output end connected to a liquid crystal display (LCD) monitor; a television tuner module installed in the computer keyboard unit and connected to the keyboard controller, wherein the television tuner module has an output end connected to an audio amplifier having an output end connected to a speaker, wherein the television tuner module is connected to an image processor, which is disposed between the television tuner module and the LVDS transmitter, wherein television tuner module is used to transform inputted audio/video signals into digital image signals and analog audio signals, then, the television tuner module outputs the digital image signals and analog audio signals, respectively, to the image processor and the LVDS transmitter, after this, the LVDS transmitter sends low-voltage differential signals to the LCD monitor, the analog audio signals are sent to the audio amplifier and then to the speaker; and a television control switch installed on the computer keyboard unit and connected to a power switching module, wherein the power switching module has an output end connected to the keyboard controller, and wherein the power switching module functions as a controller when the television control switch is activated to turn on the work power of the keyboard controller, the television tuner module, the image processor, the LVDS transmitter, the LCD monitor, the audio amplifier, and the speaker.

Other objects, advantages and novel features of the invention will become more clearly and readily apparent from the following detailed description when taken in conjunction with the accompanying drawings.

### BRIEF DESCRIPTION OF THE DRAWINGS

FIG. 1 is a side view of a notebook according to the present invention.

FIG. 2 is a block diagram showing the present invention.

FIG. 3 is a block diagram showing the audio/video signal flow when the television control switch is on according to the present invention.

FIG. 4 is a block diagram showing audio/video signal flow when the computer control switch is on according to the present invention.

FIG. 5 is a block diagram according to another preferred embodiment of the present invention.

### DETAILED DESCRIPTION OF THE PREFERRED EMBODIMENTS

It is understood that the accompanying drawings are included to provide a further understanding of the invention, and are incorporated in and constitute a part of this specification. The drawings illustrate embodiments of the invention and, together with the description, serve to explain the principles of the invention.

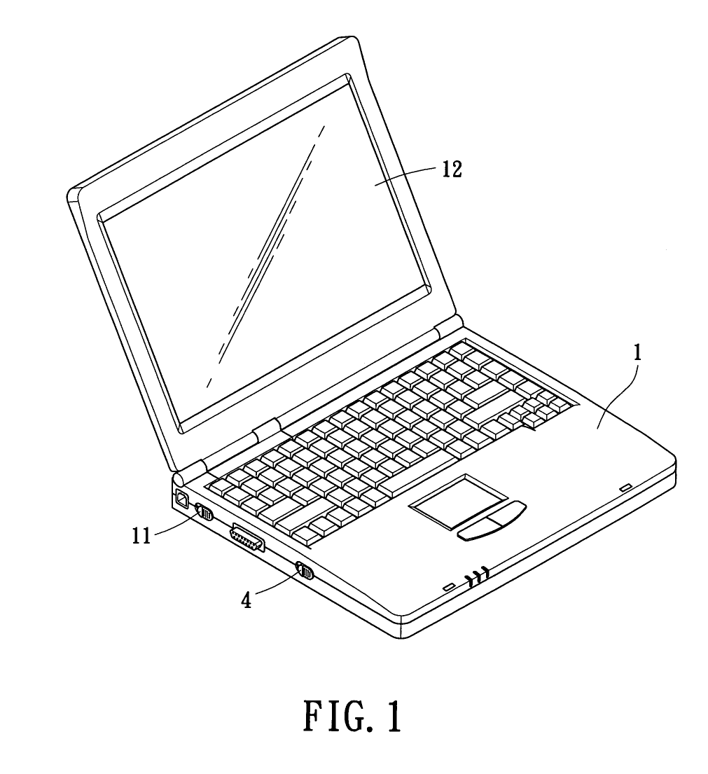

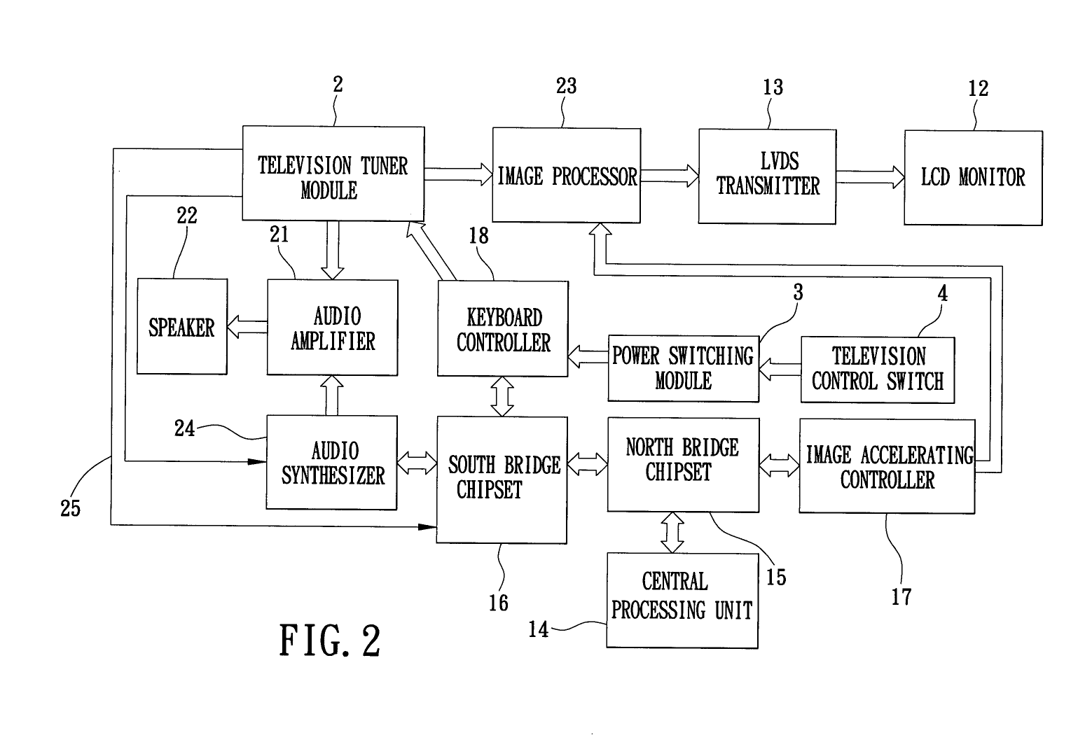

Please refer to FIG. 1 and FIG. 2. FIG. 1 is a side view of a notebook according to the present invention. FIG. 2 is a block diagram showing the present invention. The present invention pertains to a computer device that enables one to watch TV programs without the need of activating the operating system. The computer device comprises a computer keyboard unit 1, a television tuner module 2, a power switching module 3, and a television control switch 4.

A computer control switch 11 is disposed near the computer keyboard unit 1. A LCD monitor 12 is provided. The LCD monitor 12 is connected to a low-voltage differential signal (LVDS) transmitter 13. The computer keyboard unit 1 comprises an inner circuit comprising a central processing unit 14, which communicates with a north bridge chipset 15. The north bridge chipset 15 is connected with a south bridge chipset 16 and an image-accelerating controller 17. The south bridge chipset 16 is connected to a keyboard controller 18.

The television tuner module 2 is installed in the computer keyboard unit 1 and is connected to the keyboard controller 18. The television tuner module 2 has an output end connected to an audio amplifier 21, which has an output end connected to a speaker 22. An image processor 23 connects the television tuner module 2 with the LVDS transmitter 13. The television tuner module 2 is used to transform the inputted audio/video signals into digital image signals and analog audio signals. Then, the television tuner module 2 outputs the digital image signals and analog audio signals, respectively, to the image processor 23 and the LVDS transmitter 13. After this, the LVDS transmitter 13 sends low-voltage differential signals to the LCD monitor 12 for displaying. The analog audio signals are further sent to the audio amplifier 21 and then to the speaker 22. An audio synthesizer 24 is disposed between the television tuner module 2 and the south bridge chipset 16. The audio synthesizer 24 has an output end connected to the audio amplifier 21.

The power switching module 3 is connected to the keyboard controller 18. The power switching module 3 is controlled by either the television control switch 4 or the computer control switch 11 to turn on partial or overall work power.

The television control switch 4 may be disposed on the computer keyboard unit 1 and is connected to the power switching module 3. The power switching module 3 functions as a controller when the television control switch 4 is activated to turn on the work power of the keyboard controller 18, the television tuner module 2, the image processor 23, the LVDS transmitter 13, the LCD monitor 12, the audio amplifier 21, and the speaker 22.

When the television control switch 11 is on, the television tuner module 2, the image processor 23, the LVDS transmitter 13, the LCD monitor 12, the audio amplifier 21, the speaker 22, and the keyboard controller 18 are powered by the output voltage of the power switching module 3. By doing this, one can watch TV programs through the LCD monitor 12. That is, the computer functions as a normal TV.

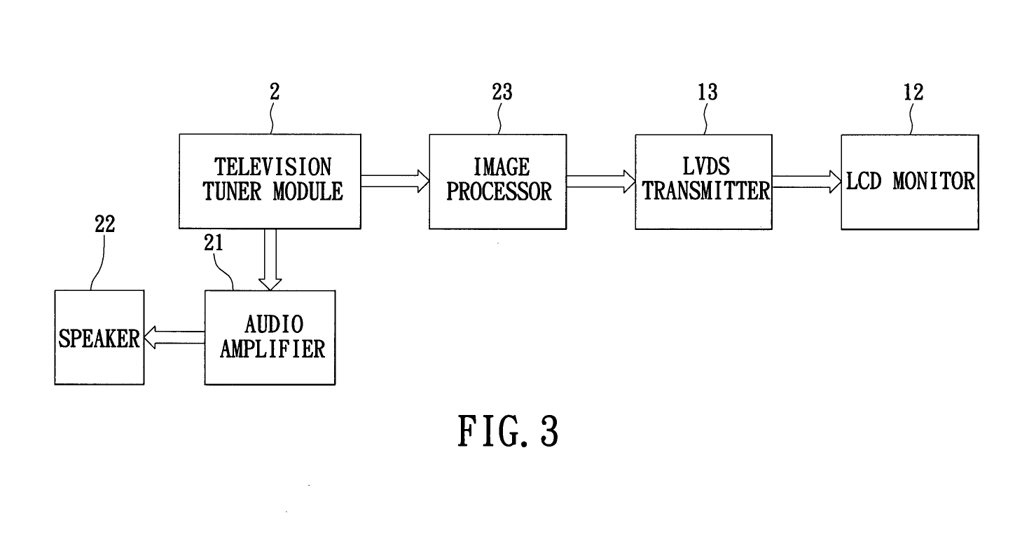

Please refer to FIG. 3. FIG. 3 is a block diagram showing the audio/video signal flow when the television control switch is on according to the present invention. As shown in FIG. 3, the image signals are transformed by the television tuner module 2 into digital image signals, which is then transmitted to the image processor 23 to output digital image signals, which is then transmitted to the LVDS transmitter 13 for sending low-voltage differential signals to the LCD monitor 12.

The audio signals are processed by the television tuner module 2 to generate left/right sound channel analog signals, which are then transmitted to the audio amplifier 21 to amplify the left/right sound channel analog signals. Then, the amplified left/right sound channel analog signals are sent to the speaker 22.

When the computer control switch 11 is on, the television tuner module 2, the image processor 23, the LVDS transmitter 13, the LCD monitor 12, the audio amplifier 21, the keyboard controller 18, the speaker 22, the audio synthesizer 24, the south bridge chipset 16, the north bridge chipset 15, the central processing unit 14, and the image accelerating controller 17 are powered by the output voltage of the television tuner module 3. In this case, one can execute any application programs through the Windows interface. For example, the user can execute the application program of the television tuner module 2 and watch TV programs through the LCD monitor. The TV programs can be permanently recorded on a media such as a CD.

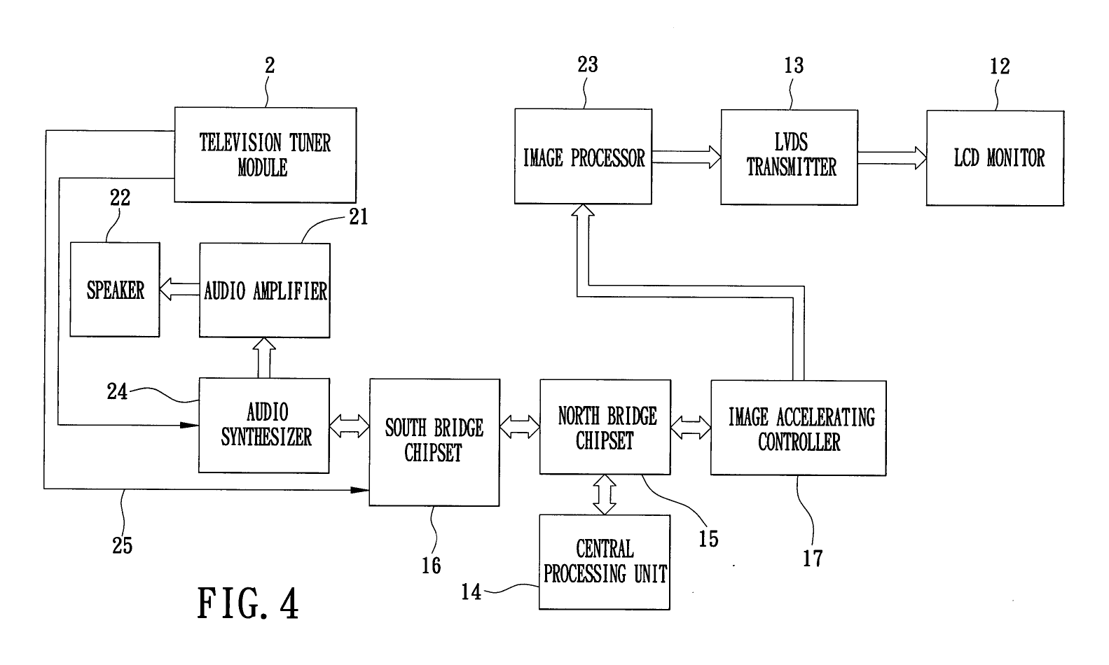

Please refer to FIG. 4. FIG. 4 is a block diagram showing audio/video signal flow when the computer control switch is on according to the present invention. As shown in FIG. 4, the image signals are transmitted by the television tuner module 2 through a USB interface 25 to the inner circuit components of the computer system. The image processing is known in the art. The image signals are processed by the south bridge chipset 16, the north bridge chipset 15, the central processing unit 14, and the image accelerating controller 17. The digital image signals are then transmitted to the image processor 23. The image processor 23 outputs the digital image signals to the LVDS transmitter 13 which sends low-voltage differential signals to the LCD monitor 12.

The audio signals are processed by the television tuner module 2 to generate left/right sound channel analog signals, which are then transmitted to the audio amplifier 21 to amplify the left/right sound channel analog signals. Then, the amplified left/right sound channel analog signals are sent to the speaker 22.

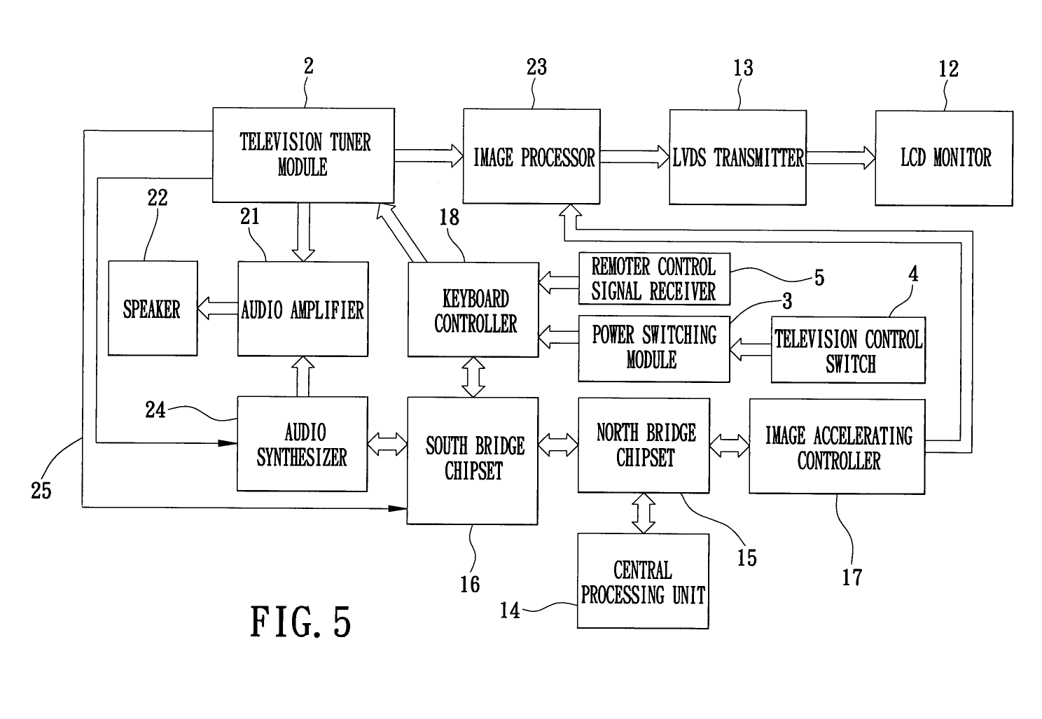

Please refer to FIG. 5. FIG. 5 is a block diagram according to another preferred embodiment of the present invention. As shown in FIG. 5, a remote control signal receiver 5 is connected to the keyboard controller 18. The remote control signal receiver 5 is used to receive remote control signals sent from a remote control to turn on the power switching module 3, the keyboard controller 18, the television tuner module 2, the image processor 23, the LVDS transmitter 13, the LCD monitor 12, the audio amplifier 21, and the speaker 22.

In summary, the features of the present invention include:

(1) The users can now watch TV programs on the computer LCD monitor without the need of executing Windows operating system, thereby creating the appendant value of the computer.

(2) It is convenient that one can use a remote control to watch TV programs on the computer LCD monitor without the need of executing Windows operating system.

(3) The present invention provides a computer device that enables a user to watch TV programs in an alternative manner.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A computer device capable of displaying television programs without the need of running an operating system in advance, comprising:
a computer keyboard unit comprising a keyboard controller, a low-voltage differential signal (LVDS) transmitter, wherein the LVDS transmitter has an output end connected to a liquid crystal display (LCD) monitor;
a television tuner module installed in the computer keyboard unit and connected to the keyboard controller, wherein the television tuner module has an output end connected to an audio amplifier having an output end connected to a speaker, wherein the television tuner module is connected to an image processor, which is disposed between the television tuner module and the LVDS transmitter, wherein television tuner module is used to transform inputted audio/video signals into digital image signals and analog audio signals, then, the television tuner module outputs the digital image signals and analog audio signals, respectively, to the image processor and the LVDS transmitter, after this, the LVDS transmitter sends low-voltage differential signals to the LCD monitor, the analog audio signals are sent to the audio amplifier and then to the speaker; and
a television control switch installed on the computer keyboard unit and connected to a power switching module, wherein the power switching module has an output end connected to the keyboard controller, and wherein the power switching module functions as a controller when the television control switch is activated to turn on the work power of the keyboard controller, the television tuner module, the image processor, the LVDS transmitter, the LCD monitor, the audio amplifier, and the speaker.

2. The computer device capable of displaying television programs without the need of running an operating system in advance as claimed in claim 1 wherein the computer keyboard unit comprises an inner circuit comprising a central processing unit, which communicates with a north bridge chipset, which is connected with a south bridge chipset and an image-accelerating controller, wherein the south bridge chipset is connected to the keyboard controller and an audio synthesizer, which is connected to the television tuner module and the audio amplifier, wherein the image accelerating controller has an output end connected to the image processor.

3. The computer device capable of displaying television programs without the need of running an operating system in advance as claimed in claim 1 wherein the computer keyboard unit comprises a computer control switch, and when the computer control switch is on, the television tuner module, the image processor, the LVDS transmitter, the LCD monitor, the audio amplifier, the keyboard controller, the speaker, the audio synthesizer, the south bridge chipset, the north bridge chipset, the central processing unit, and the image accelerating controller are powered by output voltage of the television tuner module, and wherein one can execute an application program through Windows interface.

4. A computer device capable of displaying television programs without the need of running an operating system in advance, comprising:
a computer keyboard unit comprising a keyboard controller, a low-voltage differential signal (LVDS) transmitter, wherein the LVDS transmitter has an output end connected to a liquid crystal display (LCD) monitor;
a television tuner module installed in the computer keyboard unit and connected to the keyboard controller, wherein the television tuner module has an output end connected to an audio amplifier having an output end connected to a speaker, wherein the television tuner module is connected to an image processor, which is disposed between the television tuner module and the LVDS transmitter, wherein television tuner module is used to transform inputted audio/video signals into-digital image signals and analog audio signals, then, the television tuner module outputs the digital image signals and analog audio signals, respectively, to the image processor and the LVDS transmitter, after this, the LVDS transmitter sends low-voltage differential signals to the LCD monitor, the analog audio signals are sent to the audio amplifier and then to the speaker;
a power switching module connected to the keyboard controller to turn on partial or overall work power; and
a remote control signal receiver connected to the keyboard controller, wherein the remote control signal receiver is used to receive remote control signals sent from a remote control to turn on the power switching module, the keyboard controller, the television tuner module, the image processor, the LVDS transmitter, the LCD monitor, the audio amplifier, and the speaker.

5. The computer device capable of displaying television programs without the need of running an operating system in advance as claimed in claim 4 wherein the computer keyboard unit comprises an inner circuit comprising a central processing unit, which communicates with a north bridge chipset, which is connected with a south bridge chipset and an image-accelerating controller, wherein the south bridge chipset is connected to the keyboard controller and an audio synthesizer, which is connected to the television tuner module and the audio amplifier, wherein the image accelerating controller has an output end connected to the image processor.

6. The computer device capable of displaying television programs without the need of running an operating system in advance as claimed in claim 4 wherein the computer keyboard unit comprises a computer control switch, and when the computer control switch is on, the television tuner module, the image processor, the LVDS transmitter, the LCD monitor, the audio amplifier, the keyboard controller, the speaker, the audio synthesizer, the south bridge chipset, the north bridge chipset, the central processing unit, and the image accelerating controller are powered by output voltage of the television tuner module, and wherein one can execute an application program through Windows interface.
